(19) United States
(12) Patent Application Publication
(10) Pub. No.: US 2010/0144481 A1
(43) Pub. Date: Jun. 10, 2010

(54) Hinged Fitting

(76) Inventor: Hans Werner Voss, Rockenhausen (DE)

Correspondence Address: CLARK HILL, P.C., 500 WOODWARD AVENUE, SUITE 3500, DETROIT, MI, 48226, US

(21) Appl. No.: 12/448,837

(22) PCT Filed: May 2, 2007
(86) PCT No.: PCT/DE2007/000775

§ 371 Date: Feb. 19, 2010

(30) Foreign Application Priority Data
Jan. 9, 2007 (EP) 07000307.4

(51) Int. Cl. B60N 2/225; F16H 1/32; B60N 2/44; F16H 23/10

(52) U.S. Cl. 475/164

(57) ABSTRACT

The invention relates to a hinged fitting for two components of a vehicle seat which can pivot with respect to each other about an axis (8). A first gear (1) is fixed on the first pivotable component, and a second gear (3) is fixed on the second pivotable component, and both comprise axially arranged gearing. The first gear (1) can be operatively connected to the second gear (3) by means of a roller chive which can be rotatably driven, wherein the second gear (3) comprises a gear differential with respect to the first gear (1). By means of the roller drive, the first component can swivel with respect to the second component by rolling.

The invention relates to a joint fitting for two vehicle-seat components which can be pivoted relative to one another about an axis, wherein a first gearwheel is fixed on the one pivotable component and a second gearwheel is fixed on the second pivotable component, the two gearwheels having axially oriented toothing formations, and wherein the first gearwheel can be operatively connected to the second gearwheel, which has a tooth difference in relation to the first gearwheel, by means of a rotatably driveable rolling drive, by means of which the first component can be pivoted, by way of rolling action, relative to the second component.

In the case of such a joint fitting, it is known for the first gearwheel to be located concentrically in the second gearwheel and for the toothing formations of the first and second gearwheels, these toothing formations having different numbers of teeth, to be oriented axially in the same direction.

A toothed ring is arranged for tilting action all the way round coaxially in relation to the first and second gearwheels and has its axially oriented toothing formation, which has the same number of teeth as the second gearwheel, engaging in the toothing formations of both the first and second gearwheels. By virtue of the toothed ring having a number of teeth which differs from the number of teeth of the first gearwheel, the toothed ring has its toothing formation engaging only in a partial engagement zone of the toothing formations of the first and second gearwheel. A rolling drive forces the toothed ring to engage axially in the first and the second gearwheels. Rotation of the rolling drive causes the partial engagement zone to move along the circumferences of the first and of the second gearwheels, this resulting in the two gearwheels rotating relative to one another.

DE 25 09 074 A1 discloses a joint fitting in which the two toothed rings of the two fitting parts, these toothed rings being oriented axially in the same direction, are arranged concentrically in relation to one another, wherein a swashplate which can be driven in rotation by means of a handwheel has its toothed ring, which faces toward the toothed rings of the fitting parts, engaging in the teeth of the latter such that, over a subregion of the toothed-ring circumference, the two toothed rings of the fitting parts are coupled to one another by teeth of the swashplate engaging simultaneously therein. By virtue of the handwheel being rotated, the swashplate is driven such that it can be rotated with wobbling action, and it rotates the toothed rings of the fitting parts, these toothed rings having different numbers of teeth, relative to one another.

GB 1 462 850 discloses a device which is intended for changing the rotational speed and/or the direction of the rotation and has two gearwheels, with axially facing toothing formations, arranged coaxially in relation to one another, a rotatably drivable wobbling member being arranged between the two gearwheels. The wobbling member, which is inclined in relation to the axis of rotation of the gearwheels, has axial toothing formations formed on either side and these engage, diametrically in relation to one another in each case, into the gearwheel toothing formations located opposite them.

It is an object of the invention to provide a joint fitting of the type mentioned in the introduction which, while being of straightforward and space-saving construction, can be subjected to high loading and allows the gearwheels to run satisfactorily one inside the other.

This object is achieved according to the invention in that the first gearwheel and the second gearwheel are formed with toothing formations facing toward one another and are arranged coaxially in relation to the axis to form a spacing between them, wherein a ratchet wheel is arranged in this spacing between the gearwheels, likewise coaxially in relation to the axis, and has, on either side, a respective axial toothing formation, these two toothing formations having pitches which are offset in relation to one another, wherein the rolling drive, which can be driven in a rotatable manner about the axis, can cause the ratchet wheel, with revolving rolling action, to have one side engaging, in particular in a play-free manner, in the toothing formation of the first gearwheel and, at a location diametrically opposite this, to have the other side engaging, in particular in a play-free manner, in the toothing formation of the second gearwheel, wherein the tooth difference of the toothing formation of the first gearwheel in relation to the associated toothing formation of the ratchet wheel is not equal to the tooth difference of the toothing formation of the second gearwheel in relation to the associated toothing formation of the ratchet wheel, and wherein the first gearwheel and the second gearwheel have their axially directed ring regions, which face toward one another and are located radially outside the ratchet wheel, butting against one another.

As a result of the axially oriented toothing formation, with precise rolling of the teeth, the teeth may be designed to be very wide in the radial direction, and therefore high loading can be transferred by being distributed over a large cross section. The overall size can nevertheless be kept small.

The design according to the invention results in the region of the ratchet wheel and of the toothing formations of the two gearwheels being protectively enclosed in a chamber, this being done straightforwardly without any additional components being required.

The tooth angle of the teeth is preferably somewhat larger than the angle of the coefficient of friction of the material pairing used for the gearwheels. Since this angle is approximately 6-7°, it is advantageous if the tooth angle of the teeth is approximately 9°. As a result, the axial forces which act when the gearwheels are subjected to loading lie in a moderate range of magnitude.

Rotation of the rolling drive results in the ratchet wheel wobbling with revolving action in relation to the axis, and therefore the rolling of the toothing formation of the ratchet wheel in the toothing formations of the first and of the second gearwheels results in the gearwheels rotating relative to one another and thus also in the pivotable components pivoting relative to one another.

The joint fitting can be used for seats with an adjustable backrest, for example in vehicles such as motor vehicles, but also on aircraft.

Adjustments such as, for example, height adjustments, inclination adjustments and lordosis adjustments may also be carried out on such seats.

The two toothing formations of the ratchet wheel preferably have the same number of teeth and are offset in relation to one another by half a pitch.

If the tooth overlaps of the mutually opposite toothing formations of the ratchet wheel and first gearwheel and/or of the mutually opposite toothing formations of the ratchet wheel and second gearwheel >1, then this results in the teeth of the two gearwheels rolling in a particularly precise manner one upon the other.

The first gearwheel or the second gearwheel may have a tooth difference of “0” in relation to the ratchet wheel.

This means that the ratchet wheel only rolls, but does not effect any advancement, in the gearwheel in relation to which it has a tooth difference of “0”.

If the second gearwheel or the first gearwheel has a tooth difference of “1” or of “>1” in relation to the ratchet wheel, then the gearwheel which has a tooth difference of 1 or >1 in relation to the ratchet wheel is advanced.

For the wobbling movement, the ratchet wheel can be deflected axially by the radially revolving rolling drive into a position in which it is inclined in relation to the axis and has its toothing formations engaging in the first and second gearwheels.

The ratchet wheel may be mounted in a freely rotatable manner, by way of a coaxial hole, on a stub which is coaxial in relation to the axis, wherein the ratchet wheel is mounted such that it can be deflected with wobbling action in relation to the axis, or the ratchet wheel can be deflected in an elastically deformable manner.

In order to make it possible for the interengaging teeth of the ratchet wheel and first and second gearwheels to engage at least more or less as completely as possible over the entire radial tooth length, the toothing formations of the first gearwheel and/or the second gearwheel are inclined in accordance with the inclination deflection of the ratchet wheel in relation to the axis.

This makes it possible for the teeth to be subjected to high loading.

Straightforward construction of the rolling drive is achieved if the rolling drive has a rotatably drivable drive shaft which is coaxial in relation to the axis and has two diametrically opposite, radially directed driver arms which butt axially against the ratchet wheel and can cause the ratchet wheel to be deflected axially.

A small overall size in the axial direction is achieved here if the driver arms are offset axially in the region of the drive shaft by the width of the ratchet wheel, the axial spacing between the radially outer ends of the driver arms is smaller than the width of the ratchet wheel, and the ratchet wheel is arranged between the driver arms with its coaxial hole on the drive shaft.

In order for the teeth to engage smoothly one inside the other, it is possible for the driver arms to be capable of being flexed elastically in the axial direction.

Instead of, or in addition to this, it is possible for the driver arms to be deformable in an axially resilient manner in particular in their radially outer region.

Straightforward assembly using identical components is achieved if the drive shaft comprises two identical half-shafts which each have a driver arm and butt against one another along their parting plane, the driver arms being offset axially in relation to one another.

In order to be prevent incorrect assembly of the half-shafts, the half-shafts can have in particular continuous axial recesses which are open in the direction of the parting plane and, when the half-shafts are assembled to form the drive shaft, form a complete form-coded cross section.

It is possible here to introduce here into the complete form-coded cross section a rotatably drivable actuating stub of the same cross section, via which the drive shaft is driven in rotation.

This rotary driving can take place both manually and by means of a motor, in particular an electric motor.

For the guidance of the two gearwheels, which can be rotated relative to one another, the axially directed ring region of the one gearwheel may have a concentrically encircling annular groove which is open in the direction of the other gearwheel and in which engage one or more axially projecting extensions of corresponding radial width belonging to the other gearwheel.

The first gearwheel and/or the second gearwheel are/is preferably secured by a securing element against lifting off axially from the second gearwheel and/or the first gearwheel.

Exemplary embodiments of the invention will be described in more detail hereinbelow and are illustrated in the drawing, in which:

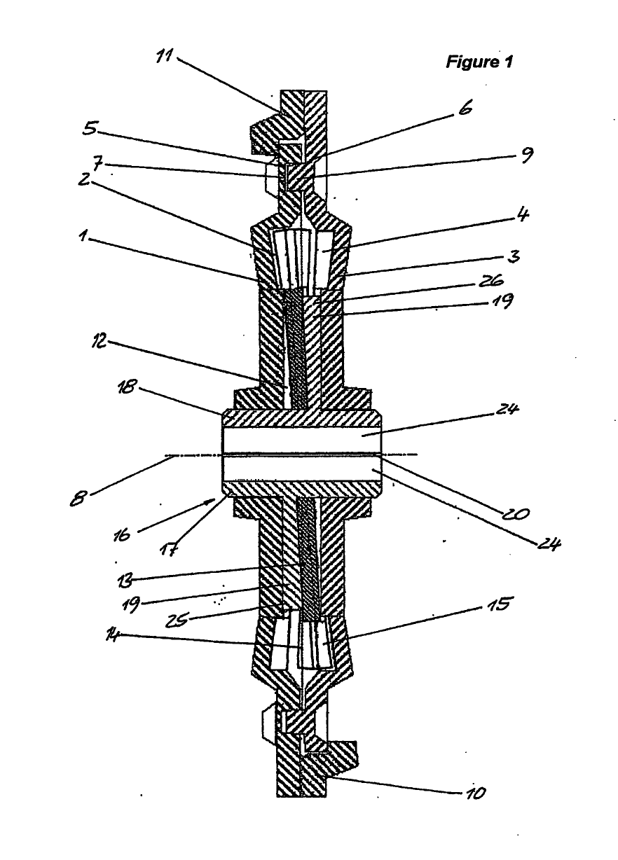

FIG. 1 shows a cross section of a first exemplary embodiment of a joint fitting,

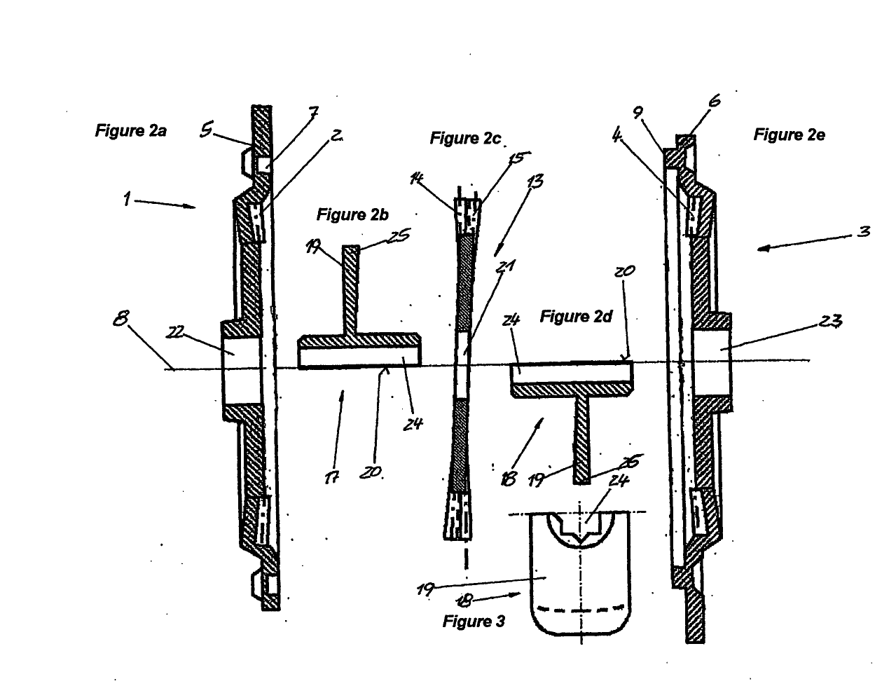

FIGS. 2a to 2e show an exploded illustration in cross section of the joint fitting according to FIG. 1,

FIG. 3 shows a side view of a half-shaft with driver arm belonging to the joint fitting according to FIG. 1,

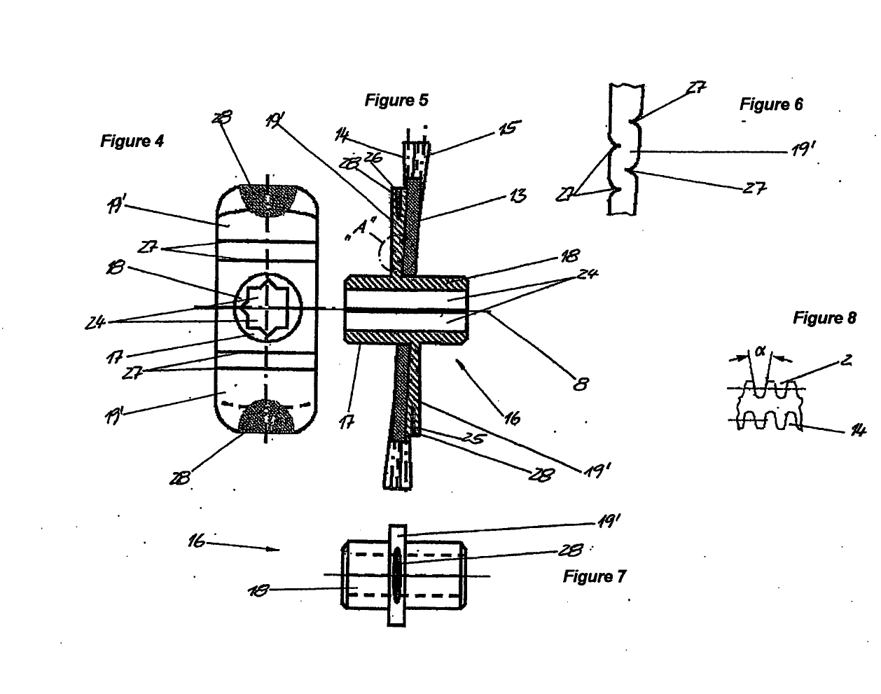

FIG. 4 shows a side view of a drive shaft with driver arms belonging to a second exemplary embodiment of a joint fitting,

FIG. 5 shows a cross section of the drive shaft according to FIG. 1 with a ratchet wheel,

FIG. 6 shows an enlarged detail “A” of the half-shaft of the joint fitting according to FIG. 4,

FIG. 7 shows a plan view of the drive shaft according to FIG. 4, and

FIG. 8 shows a plan view of a detail of the toothing formation of the first gearwheel and of that toothing formation of the ratchet wheel which faces towards the first gearwheel, these forming part of the joint fitting according to FIG. 1.

The joint fittings which are illustrated in the figures have a first gearwheel 1 with an axially oriented toothing formation 2 and a second gearwheel wheel 3 with an axially oriented toothing formation 4, the two toothing formations 2 and 4 being located axially opposite one another and facing toward one another and being designed preferably as bevel-gear toothing formations. The tooth angle “a” of the toothing formations is 18°. The two gearwheels 1 and 3 can be rotated relative to one another about an axis 8. This makes it possible for a first pivotable component (not illustrated), which is fixed to the first gearwheel 1, to be pivoted relative to a second component (not illustrated either), which is fixed to the second gearwheel 3.

The gearwheels 1 and 3 have their axially directed ring regions 5 and 6, which face toward one another and are located radially outside the toothing formations 2 and 4, butting against one another.

The ring region 5 of the first gearwheel 1 here contains an annular groove 7 which is open in the direction of the ring region 6 of the second gearwheel 3, is concentric in relation to the axis 8 and in which engages an axially projecting annular extension 9 of corresponding cross section belonging to the second gearwheel 3.

A securing element 10 is fastened in a releasable manner on the first gearwheel 1 and engages around the radially encircling periphery of the second gearwheel 3.

A corresponding securing element 11 is fastened in a releasable manner on the second gearwheel 3, diametrically opposite the securing element 10, and engages around the radially encircling periphery of the first gearwheel 1. The securing elements 10 and 11 secure the gearwheels 1 and 3 against lifting off axially from one another.

As seen in the radially inward direction from the radially outer region of the toothing formations 2 and 4, there is a spacing between the two gearwheels 1 and 3, and this spacing forms a circular-disk-like chamber 12.

A ratchet wheel 13 is arranged in this chamber 12, coaxially in relation to the axis 8, and has, on either side, a respective axial toothing formation 14 and 15, these toothing formations preferably being designed as bevel-gear toothing formations. The toothing formations 14 and 15 have the same number of teeth and are offset in relation to one another by half a pitch. They are inclined by a small amount in relation to the axis 8 in the direction of their radially outer ends.

The toothing formation 14 of the ratchet wheel 13 is located coaxially opposite the toothing formation 2 of the first gearwheel 1 and the toothing formation 15 of the ratchet wheel 13 is located coaxially opposite the toothing formation 4 of the second gearwheel 3. The geometry of the toothing formations 14 and 15 of the ratchet wheel 13 is configured so as to allow penetration into the respectively opposite toothing formation 2 or 4 of the first and second gearwheel 1 or 3, respectively.

The toothing formation 4 of the second gearwheel 3 has a tooth difference of “0” in relation to the axially opposite toothing formation 15 of the ratchet wheel 13, whereas the toothing formation 2 of the first gearwheel 1 has a tooth difference of “1” in relation to the mutually opposite toothing formation 14 of the ratchet wheel 13.

Arranged coaxially in relation to the axis 8 is a drive shaft 16 which comprises two identical half-shafts 17 and 18 which each have a radially outwardly directed driver arm 19 which is arranged eccentrically as seen over the length of the half-shafts 17 and 18.

The two half-shafts 17 and 18 butt against one another along their parting line 20, the driver arms 19 being offset axially in relation to one another.

In the axial interspace formed between the driver arms 19, the ratchet wheel 13, which is of approximately the same width, is mounted in a freely rotatable manner with its coaxial hole 21 on the outer circumference of the drive shaft 16.

Those regions of the drive shaft 16 which project axially away from the driver arms 19 project through corresponding coaxial bearing holes 22 and 23 in the first gearwheel 1 and the second gearwheel 3.

The half-shafts 17 and 18 contain continuous axial recesses 24 which open in the direction of the parting plane 20 and, when the half-shafts 17 and 18 are assembled, form a complete form-coded cross section.

This complete cross section can have inserted into it a shaft of corresponding cross section (not illustrated) of a rotary drive for the drive shaft 16.

In the event of the drive shaft 16 being driven in rotation, the axially offset driver arms 19 slide along a circular path on a respective side surface of the ratchet wheel 13.

Since the axial spacing between the radially outer free ends 25 and 26 of the driver arms 19 is smaller than the width of the ratchet wheel 13, the driver arms 19 force the ratchet wheel 13 into a tilting position in which it is inclined in relation to the axis 8. As a result of this inclination, a plurality of teeth of the toothing formations 14 and 15 in that region of the ratchet wheel 13 which is subjected to the action of a driver arm 19 penetrate into the toothing formations 2 and 4 of the first and second gearwheels 1 and 3.

The revolving action of the rotationally driven driver arms 19 also causes the ratchet wheel 13, in its inclined state, to revolve with wobbling action. As a result, the ratchet wheel 13 rolls in the toothing formation 4 of the second gearwheel 3 and advances the first gearwheel 1.

As can be seen in the case of the exemplary embodiment of FIGS. 4 to 7, the driver arms 19′ have a plurality of slots 27 on either side in the axial direction, and the driver arms 19′ can therefore be flexed elastically in the axial direction.

The driver arms 19′ also have, at their free end regions, outwardly opening radial pocket-like recesses 28. The radially outer regions of the driver arms 19′ are thus deformable in an axially resilient manner.

Both the slots 27 and the recesses 28 cause the teeth of the ratchet wheel 13 to engage smoothly in the respective toothing formations 2 and 4 of the first and second gearwheels 1 and 3.

### LIST OF DESIGNATIONS

1 First gearwheel

2 Toothing formation

3 Second gearwheel

4 Toothing formation

5 Ring region

6 Ring region

7 Annular groove

8 Axis

9 Annular extension

10 Securing element

11 Securing element

12 Chamber

13 Ratchet wheel

14 Toothing formation

15 Toothing formation

16 Drive shaft

17 Half-shaft

18 Half-shaft

19 Driver arm

19′ Driver arm

20 Parting plane

21 Coaxial hole

22 Bearing hole

23 Bearing hole

24 Axial recess

25 Free end

26 Free end

27 Slots

28 Recesses

1. A joint fitting for two vehicle-seat components which can be pivoted relative to one another about an axis, wherein a first gearwheel is fixed on the one pivotable component and a second gearwheel is fixed on the second pivotable component, the two gearwheels having axially oriented toothing formations, and wherein the first gearwheel can be operatively connected to the second gearwheel, which has a tooth difference in relation to the first gearwheel, by means of a rotatably drivable rolling drive, by means of which the first component can be pivoted, by way of rolling action, relative to the second component, characterized in that the first gearwheel (1) and the second gearwheel (3) are formed with toothing formations (2, 4) facing toward one another and are arranged coaxially in relation to the axis (8) to form a spacing between them, wherein a ratchet wheel (13) is arranged in this spacing between the gearwheels (1, 3), likewise coaxially in relation to the axis (8), and has, on either side, a respective axial toothing formation (14, 15), these two toothing formations having pitches which are offset in relation to one another, wherein the rolling drive, which can be driven in a rotatable manner about the axis (8), can cause the ratchet wheel (13), with revolving rolling action, to have one side engaging, in particular in a play-free manner, in the toothing formation (2) of the first gearwheel (1) and, at a location diametrically opposite this, to have the other side engaging, in particular in a play-free manner, in the toothing formation (4) of the second gearwheel (3), wherein the tooth difference of the toothing formation (2) of the first gearwheel (1) in relation to the associated toothing formation (14) of the ratchet wheel (13) is not equal to the tooth difference of the toothing formation (4) of the second gearwheel (3) in relation to the associated toothing formation (15) of the ratchet wheel (13), and wherein the first gearwheel (1) and the second gearwheel (3) have their axially directed ring regions (5, 6), which face towards one another and are located radially outside the ratchet wheel (13), butting against one another.

2. The joint fitting as claimed in claim 1, characterized in that the toothing formations (14, 15) on either side of the ratchet wheel (13) have the same number of teeth.

3. The joint fitting as claimed in one of the preceding claims, characterized in that the toothing formations (14, 15) on either side of the ratchet wheel (13) are offset in relation to one another by half a pitch.

4. The joint fitting as claimed in one of the preceding claims, characterized in that the tooth overlaps of the mutually opposite toothing formations of the ratchet wheel (13) and first gearwheel (1) and/or of the mutually opposite toothing formations of the ratchet wheel (13) and second gearwheel (3) >1.

5. The joint fitting as claimed in one of the preceding claims, characterized in that the first gearwheel or the second gearwheel (3) has a tooth difference of “0” in relation to the ratchet wheel (13).

6. The joint fitting as claimed in one of the preceding claims, characterized in that the second gearwheel or the first gearwheel (1) has a tooth difference of “1” or of “>1” in relation to the ratchet wheel (13).

7. The joint fitting as claimed in one of the preceding claims, characterized in that the ratchet wheel (13) can be deflected axially by the radially revolving rolling drive into a position in which it is inclined in relation to the axis (8) and has its toothing formations (14, 15) engaging in the first and second gearwheels (1, 3).

8. The joint fitting as claimed in one of the preceding claims, characterized in that the ratchet wheel (13) is mounted in a freely rotatable manner, by way of a coaxial hole (21), on a stub which is coaxial in relation to the axis (8).

9. The joint fitting as claimed in either of claims 7 and 8, characterized in that the ratchet wheel (13) is mounted such that it can be deflected with wobbling action in relation to the axis (8).

10. The joint fitting as claimed in either of claims 7 and 8, characterized in that the ratchet wheel can be deflected in an elastically deformable manner.

11. The joint fitting as claimed in one of claims 7 to 10, characterized in that the toothing formations (2, 4) of the first gearwheel (1) and/or of the second gearwheel (3) are inclined in accordance with the inclination deflection of the ratchet wheel (13) in relation to the axis (8).

12. The joint fitting as claimed in either of claims 7 and 8, characterized in that the rolling drive has a rotatably drivable drive shaft (16) which is coaxial in relation to the axis (8) and has two diametrically opposite, radially directed driver arms (19, 19′) which butt axially against the ratchet wheel (13) and can cause the ratchet wheel (13) to be deflected axially.

13. The joint fitting as claimed in claim 12, characterized in that the driver arms (19, 19′) are offset axially in the region of the drive shaft (16) by the width of the ratchet wheel (13), the axial spacing between the radially outer ends of the driver arms (19, 19′) is smaller than the width of the ratchet wheel (13), and the ratchet wheel (13) is arranged between the driver arms (19, 19′) with its coaxial hole (21) on the drive shaft (16).

14. The joint fitting as claimed in either of claims 12 and 13, characterized in that the driver arms (19′) can be flexed elastically in the axial direction.

15. The joint fitting as claimed in one of claims 12 to 14, characterized in that the driver arms (19′) are deformable in an axially resilient manner in particular in their radially outer region.

16. The joint fitting as claimed in one of claims 12 to 15, characterized in that the drive shaft (16) comprises two identical half-shafts (17, 18) which each have a driver arm (19, 19′) and butt against one another along their parting plane (20), the driver arms (19, 19′) being offset axially in relation to one another.

17. The joint fitting as claimed in claim 16, characterized in that the half-shafts (17, 18) have in particular continuous axial recesses (24) which are open in the direction of the parting plane (20) and, when the half-shafts (17, 18) are assembled to form the drive shaft (16), form a complete form-coded cross section.

18. The joint fitting as claimed in one of the preceding claims, characterized in that the axially directed ring region (5) of the one gearwheel (1) has a concentrically encircling annular groove (7) which is open in the direction of the other gearwheel (3) and in which engage one or more axially projecting extensions (9) of corresponding radial width belonging to the other gearwheel (3).

19. The joint fitting as claimed in one of the preceding claims, characterized in that the first gearwheel (1) and/or the second gearwheel (3) are/is secured by a securing element (10, 11) against lifting off axially from the second gearwheel (3) and/or the first gearwheel (1).
